(19) United States
(12) Patent Application Publication
(10) Pub. No.: US 2026/0285470 A1
(43) Pub. Date: Sep. 24, 2026

(54) Continuous Aircraft Structure

(71) Applicant: SUPERNAL, LLC, Irvine, CA (US)

(72) Inventors: Rajan Khatri, Irvine, CA (US); Mark Bjornholm, Irvine, CA (US)

(21) Appl. No.: 19/475,728

(22) PCT Filed: Apr. 18, 2024
(86) PCT No.: PCT/US2024/025242

§ 371 Date: Oct. 15, 2025

Related U.S. Application Data
(60) Provisional application No. 63/460,588, filed on Apr. 19, 2023.

(51) Int. Cl. B64C 1/18; B29C 70/44; B29L 31/30; B64C 1/00; B64C 1/12

(52) U.S. Cl. CPC B64C 1/18; B29C 70/443; B64C 1/12; B29L 2031/3082; B64C 2001/0072

(57) ABSTRACT

A method of forming a structural component is provided. The method includes forming, by arranging at least one composite material to a first determined configuration, a first uncured composite laminate beam structure. The method also includes forming, by arranging at least one composite material to a second determined configuration, a second uncured composite laminate beam structure. The method further includes co-curing a first surface of the first uncured composite laminate beam structure to a first surface of the second uncured composite laminate beam structure to form a composite laminate beam structure, where the composite laminate beam structure is a single continuous structure. The method additionally includes coupling a surface of the composite laminate beam structure to an internal surface of a skin.

### CROSS REFERENCE TO RELATED APPLICATION

The present application claims priority to U.S. Provisional Patent Application No. 63/460,588, filed on Apr. 19, 2023, the entire contents of which are herein incorporated by reference as if fully set forth in this description.

### BACKGROUND

Aircraft utilize airframes to transfer loading experienced during operation in the air and on the ground. The airframes include numerous parts assembled together. Assembly requires fastening the parts together using fastening devices, such as nuts and bolts, and/or adhesives to allow loading to transfer between the parts. Constraints, such as manufacturing, design, or repairability, can necessitate some structural parts being assembled from numerous sub-parts.

Assembling a structural part from numerous sub-parts poses drawbacks. Unlike a continuous structure, structures made from numerous sub-parts rely on the fastening devices to transfer load from one part to the next. Fasteners may add considerable weight to the aircraft. Additionally, weight can be added when the sub-parts are overlapped in order to facilitate coupling. Adding extra weight to the aircraft may reduce performance of the aircraft, including reduced range, maneuverability, and/or energy efficiency. Further, such fasteners often require holes to be drilled in the mating sub-parts, which may cause damage and may weaken the structural capabilities of the parts. High load transfer through the fasteners may increase local stresses the parts experience at the hole locations, which may require inspection resulting in extended periods of downtime for the aircraft. Thus, there is an ongoing need to develop stronger aircraft structures while reducing overall aircraft weight.

### SUMMARY

Embodiments described herein relate to aircraft structures methods of forming aircraft structures. The aircraft structures described herein may provide increased strength while reducing overall aircraft weight.

In an example embodiment, a method of forming a structural component is provided. The method includes forming, by arranging at least one composite material to a first determined configuration, a first uncured composite laminate beam structure. The method also includes forming, by arranging at least one composite material to a second determined configuration, a second uncured composite laminate beam structure. The method further includes co-curing a first surface of the first uncured composite laminate beam structure to a first surface of the second uncured composite laminate beam structure to form a composite laminate beam structure, where the composite laminate beam structure is a single continuous structure. The method additionally includes coupling a surface of the composite laminate beam structure to an internal surface of a skin.

In some examples, the method further includes prior to co-curing, applying an adhesive between the first surface of the first uncured composite laminate beam structure and the first surface of the second uncured composite laminate beam structure.

In some examples, forming the first uncured composite laminate beam structure further includes arranging a plurality of carbon fiber plies on a mold; sealing the arranged plurality of carbon fiber plies in a vacuum bag; and injecting a matrix into the vacuum bag.

In some examples, co-curing a first surface of the first uncured composite laminate beam structure to a first surface of the second uncured composite laminate beam structure further includes co-curing a bulkhead to the composite laminate beam structure.

In some examples, the method further includes forming, by arranging at least one composite material to a third determined configuration, a first uncured composite laminate flange; and co-curing a first surface of the first uncured composite laminate flange to a second surface of the first uncured composite laminate beam structure.

In some examples, coupling the surface of the composite laminate beam structure to the internal surface of the skin includes bonding a first surface of the composite laminate beam structure to a first internal surface of the skin and detachably coupling a second surface of the composite laminate beam structure to a second internal surface of the skin.

In some examples, the method further includes forming, by arranging at least one composite material to a third determined configuration, a third uncured composite laminate beam structure; and co-curing a second surface of the first uncured composite laminate beam structure to a first surface of the third uncured composite laminate beam structure such that the composite laminate beam structure forms a continuous I-beam configuration.

In some examples, the method further includes co-curing respective second surfaces of the second and third uncured composite laminate beam structure to the internal surface of the skin.

In some examples, coupling the composite laminate beam structure to the skin includes co-curing the composite laminate beam structure to the skin.

In some examples, the method further includes, prior to co-curing the composite laminate beam structure to the skin, applying an adhesive between coupling surfaces of the composite laminate beam structure and the skin.

In another example embodiment, an aerial vehicle includes a body, a lift surface coupled to the body, and a boom coupled to the lift surface at a distance from the body. The boom includes a first fairing, a second fairing coupled to the first fairing, and a continuous structural beam. The second fairing is a continuous structural member. The continuous structural beam is internally disposed within a cavity formed by the first and second fairings, and coupled to a surface of the second fairing, where the continuous structural beam is formed of a first composite laminate co-cured with a second composite laminate.

In some examples, the continuous structural beam is co-cured with the second fairing.

In some examples, the continuous structural beam forms an I-beam.

In some examples, a first surface of the I-beam is coupled to the surface of the second fairing and a second surface of the I-beam is coupled to a surface of the first fairing.

In some examples, the I-beam bisects the boom into a first and second sides, and the first fairing includes a first access panel that allows access to the first side and a second access panel that allows access to the second side.

In some examples, the second fairing comprises a structural skin.

In some examples, the first composite laminate is co-cured to the second composite laminate at a substantially perpendicular angle.

In some examples, the first composite laminate extends a width of the second fairing such that the first composite laminate is coupled to opposite surfaces of the second fairing.

In some examples, the second composite laminate is coupled to the surface of the second fairing at a substantially perpendicular angle to the first composite laminate.

In some examples, the first composite laminate forms a structural skin and the second composite laminate forms a floor.

These as well as other aspects, advantages, and alternatives will become apparent to those of ordinary skill in the art by reading the following detailed description, with reference, where appropriate, to the accompanying drawings.

### BRIEF DESCRIPTION OF THE DRAWINGS

FIG. 1 is a craft in a vertical take-off and landing configuration, according to an exemplary embodiment of the present disclosure.

FIG. 2 is a perspective view of aspects of a craft, according to an exemplary embodiment of the present disclosure.

FIG. 3A is a top view of aspects of a craft, according to an exemplary embodiment of the present disclosure.

FIG. 3B is a side view of aspects of a craft, according to an exemplary embodiment of the present disclosure.

FIG. 3C is a front view of aspects of a craft, according to an exemplary embodiment of the present disclosure.

FIG. 4 is a perspective view of a boom assembly, according to an exemplary embodiment of the present disclosure.

FIG. 5A is a cross-sectional view of a boom assembly, according to an exemplary embodiment of the present disclosure.

FIG. 5B is a cross-sectional view of a boom assembly, according to an exemplary embodiment of the present disclosure.

FIG. 5C is a cross-sectional view of a boom assembly, according to an exemplary embodiment of the present disclosure.

FIG. 6 is a process flow for assembling structural components of a boom assembly, according to an exemplary embodiment of the present disclosure.

FIG. 7 is a flow chart of an example method of forming a structural portion of a boom assembly, according to an exemplary embodiment of the present disclosure.

### DETAILED DESCRIPTION

Disclosed herein are examples of structures, processes, and methods for forming single continuous structural components, such as a continuous structural boom. In some embodiments, the single continuous structural component may be part of a vehicle. In some embodiments, the vehicle may be a VTOL, which may or may not use propellers to hover, takeoff, and/or land. It should be understood that in other embodiments, the vehicle may be any other type of vehicle that may be able to utilize the advantages of the present invention, such as a ground vehicle (i.e., an automobile), a sea vehicle (such as a boat), or a flying craft (such as an aerial, floating, soaring, hovering, airborne, aeronautical aircraft, airplane, plane, spacecraft, a helicopter, an airship, or an unmanned aerial vehicle, or a drone).

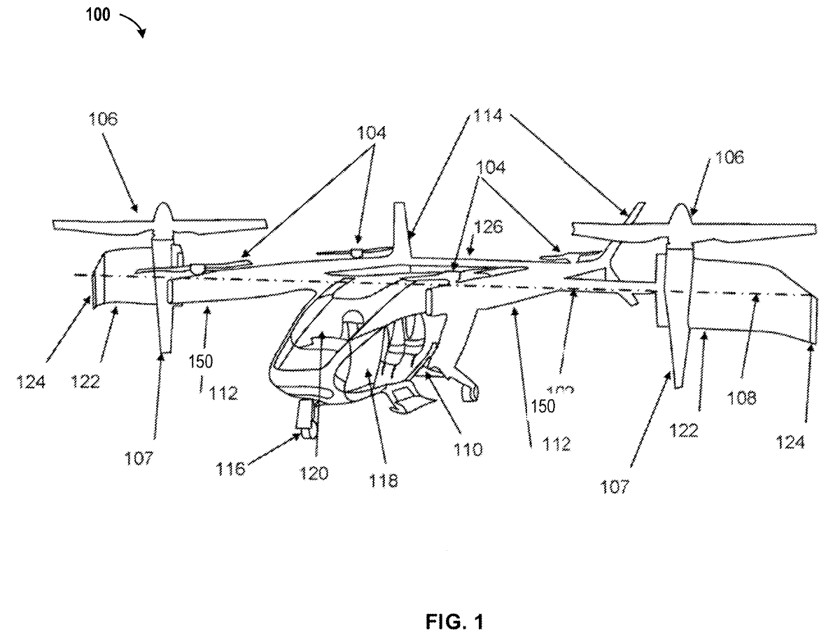

FIG. 1 illustrates a craft 100 in a vertical take-off and landing configuration, according to an exemplary embodiment of the present disclosure. As shown in FIG. 1, the craft 100 may include, among other things, a body 110, one or more lift rotors 104, one or more proprotors 106 which may be mounted on respective hubs 107, one or more boom assemblies 150, one or more lift surfaces 102, and a tail 114. In some embodiments, the craft 100 may be manned or unmanned. The craft 100 may be used for any purpose known to those skilled in the art, including for example, as a taxi, a delivery vehicle, a personal vehicle, a cargo transport, a short or long-distance hauling aircraft, and/or a video/photography craft. Thus, in some embodiments, the craft 100 may be a manned and/or unmanned aerial vehicle (e.g., aircraft).

The body 110 may be any suitable shape, size, or configuration suitable for the purpose of the craft, as will be understood by a person of ordinary skill in the art. For example, the body 110 may be oval, square, triangular, or otherwise any appropriate shape sufficient to hold cargo and/or passengers while remaining structurally sound. Moreover, the body 110 may include gear 116 for landing on land and/or water, which may or may not be retractable. The gear 116 may be included at both the front and the back of the craft 100, and may include wheels, treads, pontoons, or other components that may aid the craft in landing in land and/or water. The body 110 may also include a cockpit 118 configured to hold a pilot, passenger(s), and/or cargo.

In one example, the pilot may be located at the front of the aircraft and the passengers and/or cargo may be located behind the pilot. However, in other embodiments, the pilot could be located at any location within the body (or that the craft could be maneuvered without a pilot at least some of the time). The body 110 may also include a windshield 120 of any suitable shape and size; one or more doors configured to open and/or close (e.g., by swinging, sliding, and/or raising/lowering) to allow ingress/egress of persons and/or cargo; one or more seats; and controls and/or a computer system configured to communicate and/or control craft systems for the craft, including for example, the proprotors 106, the lift rotors 104, and/or one or more control surfaces (e.g., elevator, rudder, ruddervator, actuator, spoiler, or other known controls/surfaces). The body 110 may include a fuselage configured to provide structure to connect and/or link a lift surface structure of the lift surface 102. In some embodiments, the fuselage may be of truss, monocoque, or semi-monocoque construction. The fuselage may be constructed of any suitable material, such as metal and/or a composite laminate. In some examples, the fuselage may include aluminum, while in other examples the fuselage may include a carbon fiber composite laminate. In further examples, the fuselage may include a combination of metal and composite laminate.

The proprotors 106 and/or the lift rotors 104 may be positioned above or away from control surfaces and/or portions of the body 110 such that a blade strike is unlikely or not possible. For example, the proprotors 106 may be spaced above a proprotor hub 107 and/or the lift rotors 104, when in a vertical take-off and landing configuration. The proprotors 106 may be spaced along the lift surface 102 and substantially above the body 110, and/or the lift rotors 104 may be spaced along the boom assemblies 150 and substantially above the body 110. The proprotors 106 may be spaced along the lift surface 102 away from the tail 114 (e.g., outboard) to avoid a blade strike on the tail 114. For example, each proprotor 106 may be positioned at more than half the distance of one wing from the body 110 or, in some embodiments, more than two-thirds the distance of one wing from body 110.

The proprotors 106, the lift rotors 104, and/or controls may be operable by an onboard pilot, an onboard computer (e.g., autonomously), from a control outside of the craft (e.g., remotely), or a mixture of one or more of an onboard pilot, an onboard computer, and/or a control outside of the aircraft. The proprotor 106 may be configured to be controlled through a power control (e.g., throttle), a pitch control (e.g., collective) and/or an angle of attack control (e.g., cyclically), or any suitable combination of these controls. Each of these controls may comprise mechanical and electrical actuators, switches, or other controls known to one of ordinary skill in the art, in conjunction with one or more processors (e.g., within controllers, computers) to effect operation and management of each individual control or as a subset of controls or all controls altogether.

The lift surface 102 may extend relatively horizontally, when the craft is at rest, from one end to another. The lift surface 102 may include an airfoil configured to generate lift when air flows past it. The lift surface 102 may be a single continuous surface, or may include sections of lift surfaces, for example with one or more sections arranged inboard (e.g., towards the body 110) of the boom assemblies 150 (discussed below) and one or more sections arranged outboard (e.g., away from the body 110) of the boom assemblies 150. The lift surface 102 may incorporate portions of, or include shaped portions of, the body 110, the boom assemblies 150, and/or the proprotors 106 to generate lift and/or reduce drag as air flows past.

The boom assemblies 150 may provide a structure for the tail structure 114, one or more electric motors for the one or more lift rotors 104, and/or one or more batteries to power the one or more lift rotors 104, and/or the one or more proprotors 106. The lift rotors 104 may also be connected to the craft's electrical and control systems. The boom assemblies 150 may be supported by the lift surface 102 and the internal structure of the lift surface. Thus, the structure of the lift surface 102 may efficiently provide lift to the craft 100 to carry persons or cargo while incorporating structure to support the boom assemblies 150, and/or additionally to support the proprotors 106 in horizontal thrust and vertical take-off and landing configurations. Additionally, the proprotors 106 can create stress on structure as it rotates, and it is thus advantageous to support the proprotors 106 through the lift surface 102 that comprises internal structural components, such as spars and ribs, that are capable of withstanding the stress from the proprotors 106 as they operate to generate thrust and as they rotate between configurations. Efficient use of the structure in the lift surface 102 can provide for a lighter craft, leading to less use of fuel and travel at greater speeds.

While FIG. 1 illustrates four lift rotors 104, any suitable number of lift rotors 104 may be incorporated in a craft (for example, the craft may utilize more or less than four lift rotors 104). Lift rotors 104 may be configured to generate substantially vertical thrust. Lift rotors 104 may operate at a fixed pitch and/or a fixed revolutions per minute (RPM). In some embodiments, the lift rotors 104 may be positioned one either side of a lift surface and along the boom assemblies 150. In some embodiments, the lift rotors 104 may be positioned on the lift surface 102.

The lift rotors 104 and the proprotors 106 may be mechanically powered by one or more electric motors. In some embodiments, each lift rotor 104 and/or proprotor 106 may be powered by a dedicated motor, or one or more lift rotors 104 and/or proprotors 106 may be powered by a shared motor. As one example, two lift rotors 104 along one boom assembly 150 may share a motor. The motors discussed herein may be traditional fuel powered motors, electric motors, and/or hybrid motors. In some embodiments, a motor and rotor may be connected to a transmission that controls the use power generated by the motor. The transmission may be a continuously variable transmission (CVT), or an automatic transmission, or a manual or semi-manual transmission to shift one or more gears to output differing amounts of power.

The lift rotors 104 and/or the proprotors 106 may be constant speed rotors or variable speed rotors. The lift rotors and/or the proprotors may be at a constant angle of attack or have a changeable angle of attack (e.g., changeable through one or more actuators).

Speed, position, and/or angle of attack may be changed and/or gear may be shifted individually, as a set at the same time, or for all proprotors 106 and/or all lift rotors 104 simultaneously. For example, four lift rotors 104 may all change speed at once to initiate a takeoff sequence and/or landing sequence. As another example, the proprotors 106 may be shifted from a take-off and landing configuration to a cruise condition simultaneously. As another example, two proprotors 106 and four lift rotors 104 may all change speed and/or angle of attack to affect a take-off and landing sequence simultaneously.

The lift rotors 104 may be located at any position on the craft 100. As illustrated in FIG. 1, a first lift rotor 104 may be positioned forward of the lift surface 102 on a first side of the body, a second lift rotor 104 may be positioned aft of the lift surface on the first side of the body, a third lift rotor 104 may be positioned forward of the lift surface on a second side of the body, and a fourth lift rotor 104 may be positioned aft of the lift surface on the second side of the body. The lift rotors 104 may also be mounted on the one or more boom assemblies 150. The one or more boom assemblies 150 may include a battery pack configured to supply electrical power to one or more electric motors or may be utilized for storage of goods, electrical or mechanical components of the craft, or any other items known to those skilled in the art. While FIG. 1 illustrates two boom assemblies 150 configured substantially perpendicular to the top or bottom surface of the lift surface 102, in other embodiments more or less than two booms may be utilized, and they may be attached using known attachment techniques and/or arranged in any suitable configuration. The one or more boom assemblies 150 may include or connect to the tail 114 that comprises one or more control surfaces (e.g., one or more of an elevator, a rudder, a ruddervators, a spoiler, or similar).

Control surfaces may be on relatively vertical portions of the tail 114 or relatively horizontal portion 126 of the tail 114. The tail 114 may be linked aft of the boom assemblies 150. In some embodiments, the tail 114 may be linked aft of the lift surface 102. The tail 114 may comprise an elevator along the link between one boom assembly 150 and another boom assembly 150. The tail structure 114 may be aft of the body 110. The tail structure 114 may comprise control surfaces such as rudders and/or ruddervators, where the control surfaces extend upwards and/or downwards from the boom assemblies 150. In some embodiments, at least one control surface may be positioned at least partially above a rotation plane of the lift rotors. For example, a rudder, an elevator, or a ruddervators of the tail 114 may extend partially above the body 110 and/or the lift rotors 104. The tail 114 may be configured to provide control to the craft 100 through control surfaces that are positioned in a freestream (e.g., relatively undisrupted air) when the craft is in a horizontal thrust configuration.

As discussed in greater detail below, a number of tail configurations are contemplated, including a T-tail, cruciform tail, dual tail, triple tail, V-tail, Bronco tail, low boom tail, or high boom tail. A Bronco tail may have relatively perpendicular vertical and horizontal surfaces. The tail 114 may have rounded edges between substantially vertical and horizontal surfaces to provide efficient support of substantially horizontal surfaces by the substantially vertical surfaces, considered when the craft 100 is at rest on a ground surface. In some embodiments, the tail 114 may extend from the body 110 and the boom assemblies 150 may be connected above the tail 114 extending from the body 110, where the connection of the boom assemblies 150 is separate from the tail 114 extending from the body 110 or connected to the tail 114 extending from the body 110.

The proprotors 106 may be connected to the lift surface 102 through a rotating linkage such as a rotating spar, and/or extending linkages. In some embodiments, the rotating spar may be actuated to rotate the proprotor 106 relative to the lift surface 102. The proprotors 106 may be positioned at any suitable location on the craft, including on the lift surface, on one or more sides of the body 110, on the boom assembly 150, or any other location. In some embodiments, extending linkages may be actuated to rotate the proprotor 106 relative to the lift surface 102. Actuators configured to actuate spars and/or rotating linkages may comprise one or more of a rotating actuator or a linear actuator.

The proprotors 106 may be configured in one configuration to rotate around and/or relative to an axis 108 substantially parallel with a ground surface and/or a lift surface, considered when the aircraft is at rest on the ground surface. As shown in FIG. 1, the axis 108 may extend along or within the lift surface 102 from one end of the lift surface 102 to another end of the lift surface 102. The lift surface may include a first partial lift surface 122 at a first end of the lift surface 102 and a second partial lift surface 122 at a second end of the lift surface 102. The first and second partial lift surfaces may have any shape suitable to maximize lift and minimize drag, thereby reducing fuel consumption. For example, the partial lift surface may be rectangular, circular, triangular, or any combination thereof.

In some embodiments, a first proprotor 106 may be attached to the first partial lift surface such that the first partial lift surface moves with the proprotors 106 during movement of the proprotor 106 relative to and/or rotation about axis 108. A second proprotor 106 may be attached to the second partial lift surface such that the second partial lift surface moves with the proprotors 106 during movement of the proprotor 106 relative to and/or rotation about axis 108. The partial lift surfaces 122 may include one or more control systems which may be operable by the pilot located in the cabin 118. The partial lift surfaces 122 may be operated via actuators, active inceptors, sidesticks, switches, and/or buttons and may be configured to generate lift for vertical take-off and/or landing craft in a horizontal thrust configuration.

In some embodiments, the partial lift surfaces 122 may be configured to generate lift in a vertical thrust configuration. In some embodiments, the partial lift surfaces 122 may comprise a wing portion with a similar cross-sectional area and/or airfoil shape to the rest of the lift surface 102 (e.g., partial lift surfaces 122 may comprise a continuation of the lift surface 102). In some embodiments, the partial lift surfaces 122 may comprise winglets, may consist of winglets, and in other embodiments, the partial lift surfaces 122 may not have winglets. Whether the partial lift surfaces 122 have winglets may depend on the type of cargo, travel time, and/or proprotor size. The partial lift surfaces 122 may each comprise a winglet 124 and a wing portion, as shown in FIG. 1. The winglets 124 may extend generally vertically from the end of the wing portions. In some embodiments, the winglets 124 may be configured to reduce drag.

In some embodiments, the proprotors 106 may be configured to rotate or move about the axis 108 along with the partial lift surfaces 122, where the proprotors 106 and the partial lift surfaces 122, 124 rotate outboard of the boom assemblies 150. In some embodiments, where the lift surface 102 is a separate structure from the boom assemblies 150, the proprotors 106 may move or rotate with the lift surface 102 aside from portions of the lift surface 102 that include the body 110. In some embodiments, the proprotors 106 may move or rotate such that only a portion of the proprotor hub 107 and the blades 106 move or rotate. In some embodiments, the proprotor hub 107 may move or rotate with the partial lift surface 122 about axis 108. Based on the shape of the lift surface 102, the lift surface not including the body 110 may rotate with the proprotors 106 to increase lift and decrease drag, thereby reducing fuel consumption. The lift surface 102 shape may also vary throughout a root to tip length. For example, the lift surface 102 may be rectangular shaped to support the weight of the body 110, and may be thinner out to the proprotor 106 to reduce drag when the proprotor 106 is configured for horizontal operation and wider when the proprotor 106 is configured for vertical operation.

In some embodiments, the rotors described herein may be referred to as a propeller or a prop. Further, in some embodiments, the proprotors described herein may be referred to as a propeller, a tilting propeller, a prop, or a tilting prop.

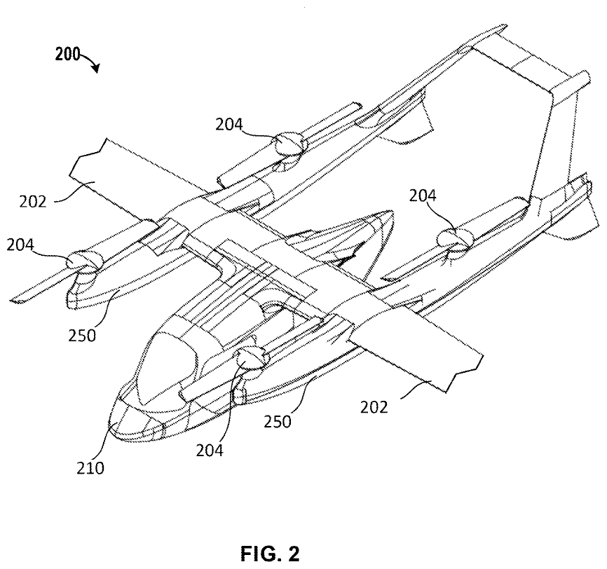

FIG. 2 is a perspective view of aspects of a craft 200, according to an exemplary embodiment of the present disclosure. In some embodiments, the craft 200 may include a body 210, a lift surface 202, a boom assembly 250, and lift rotors 204. The lift surface 202 may be coupled to the body 210 and the boom assembly 250. The boom assembly 250 may include the lift rotors 204 disposed along a length of the boom assembly 250, such as forward and aft of the lift surface 202. For purposes of illustration, only a portion of the craft 200 is shown in FIG. 2. The craft 200 may have similar components, features, and/or capabilities as the craft 100 described in FIG. 1.

In some embodiments, the lift surface 202 may include a structural unit, such as one or more spars and/or pylons, configured to facilitate coupling of the boom assembly 250. Similarly, in some embodiments, the boom assembly 250 may include an internal structural unit that may couple to the structural unit of the lift surface 202. A portion of the boom assembly 250 may be shaped to mirror a portion of the lift surface 202 to facilitate coupling. For example, a portion of the boom assembly 250 may mirror an upper surface and/or a lower surface of the lift surface 202. In some embodiments, mirroring a surface of the lift surface 202 may reduce aerodynamic drag on the craft 200, thereby increasing aerodynamic efficiency. In the example embodiment shown in FIG. 2, the boom assembly 250 couples to the lift surface 202 such that the lift surface 202 is enclosed by the boom assembly 250 at the coupling location. In this instance, the boom assembly 250 may form an aperture shaped substantially similar to the shape of the lift surface 202. A portion of the boom assembly 250 may reside above and below the lift surface 202. The portion of the boom assembly 250 residing above the lift surface 202 may match the contour of the upper surface of the lift surface 202. In some embodiments, the portion of the boom assembly 250 residing above the lift surface 202 may be structural, while in other embodiments the portion of the boom assembly 250 residing above the lift surface 202 may serve an aerodynamic purpose. In such embodiments, the structural portion of the boom assembly 250 may reside below the lift surface 202. In further embodiments, the boom assembly 250 may reside completely below the lift surface 202, completely above the lift surface 202, or substantially in-line with the lift surface 202.

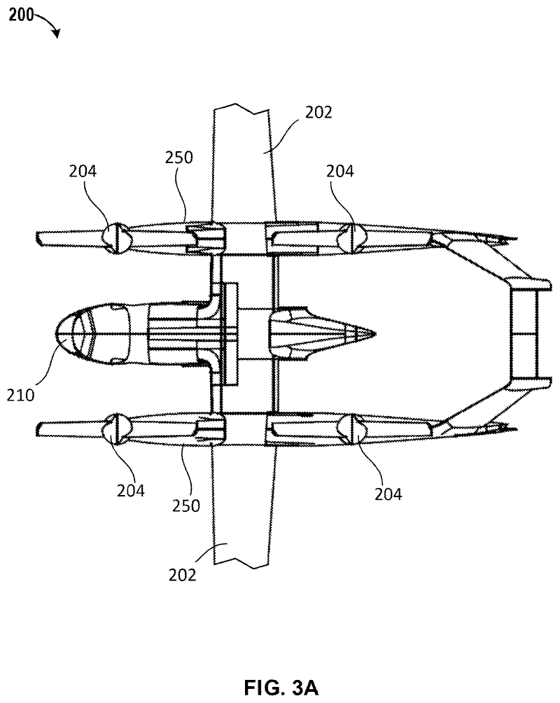

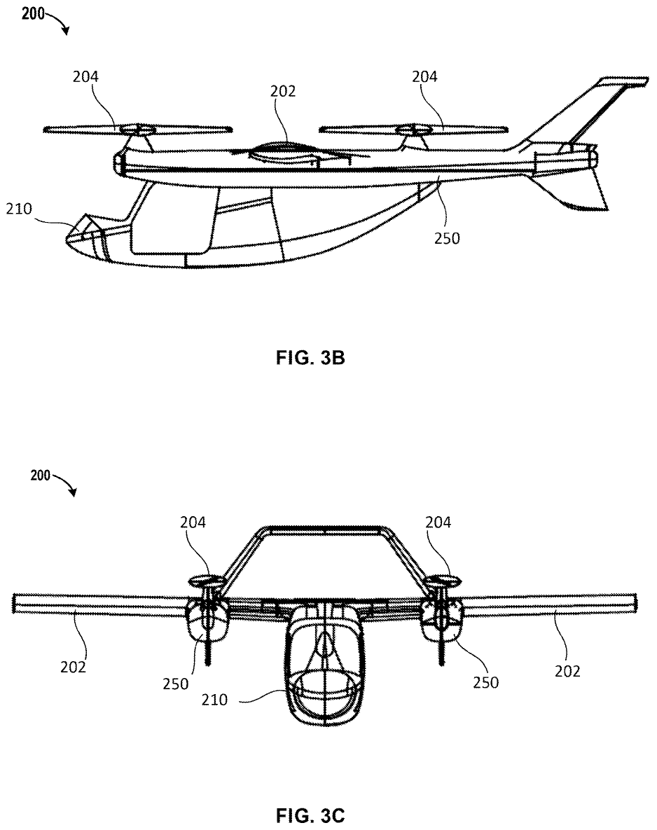

FIGS. 3A-3C are a top, side, and front view of aspects of a craft 200, according to an exemplary embodiment of the present disclosure. For purposes of illustration, only a portion of the craft 200 is shown in FIGS. 3A-3C. In some embodiments, the craft 200 may include the boom assembly 250 disposed on the lift surface 202 and located on either side of the body 210. For example, in some embodiments, the craft 200 may include a first boom assembly disposed on a first side of the body 210 and a second boom assembly disposed on a second side, opposite the first side, of the body 210. A first portion of each boom assembly 250 may extend forward of the lift surface 202 and a second portion of each boom assembly 250 may extend aft of the lift surface 202. The first and second portions of each boom assembly 250 may each respectively include the lift rotors 204.

In some embodiments, the lift rotors 204 may be disposed on the boom assembly 250 and extend above an upper surface of the lift surface 202. Having the lift rotors 204 extend above the lift surface 202 may allow for improved aerodynamic performance of the craft 200 by reducing interference of airflow over the lift surface 202 during flight. This may further provide increased safety to pilots, passengers, and crew as the lift rotors 204 are not in line with the body 210. In some embodiments, the portion of the boom assembly 250 below the lift surface 202 may be structural, while the portion of the boom assembly 250 in-line with and/or above the lift surface 202 may be non-structural, such as an aerodynamic fairing.

In some embodiments, non-structural components may experience loading, for example gravitational forces, but the structural load carrying capabilities of the non-structural part are not contemplated in the load carrying capabilities of the overall structure.

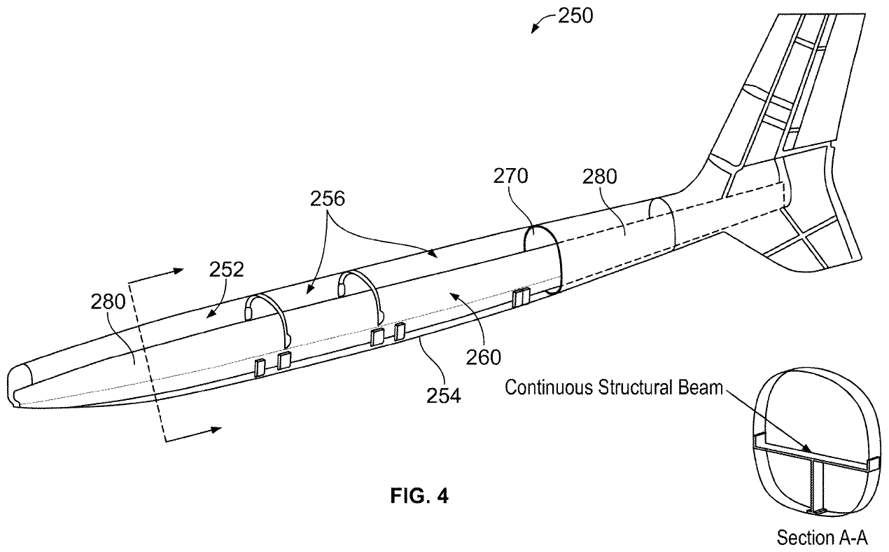

FIG. 4 is a perspective view of a boom assembly 250, according to an exemplary embodiment of the present disclosure. In some embodiments, the boom assembly 250 may include an upper fairing 252, a lower fairing 254, and a canoe support structure 260 disposed internally between the upper fairing 252 and lower fairing 254. In some embodiments, a plurality of ribs 270 may be disposed along a length within the boom assembly 250.

In some embodiments, the upper fairing 252 may span a length of the boom assembly 250 and may couple to the lower fairing 254. Together, the upper fairing 252 and lower fairing 254 may form an aerodynamic surface of the boom assembly 250. The aerodynamic surface may serve to reduce aerodynamic drag of the craft 200 during flight, thus contributing to increased efficiency of the craft 200. The upper fairing 252 and lower fairing 254 may define an internal cavity of the boom assembly 250 where the canoe support structure 260 and the ribs 270 may reside. In some embodiments, the upper fairing 252 may be a first fairing and the lower fairing 254 may be a second fairing.

In some embodiments various components, such as a battery and/or a motor, may be housed within the internal cavity of the boom. In some embodiments, the upper fairing 252 may include at least one access panel 256. The access panel 256 may be used to access the various components, the canoe support structure 260, the lift rotor coupling 280, and/or the ribs 270 located within the internal cavity. However, in other embodiments the upper fairing 252 may not include the access panel 256.

In some embodiments, the upper fairing 252 may be a single continuous piece. In such embodiments, the upper fairing 252 may include cutouts where the access panels 256 may be removably coupled to the upper fairing 252 at the cutout locations. In operation, the access panels 256 may be removed without having to remove the upper fairing 252. In other embodiments, however, the upper fairing 252 may be made from more than one piece. For example, the boom assembly 250 may include an upper fairing 252 comprising multiple segments adjacent to one another and spaced along the length of the boom assembly 250. Each segment may couple to at least one rib 270 on the boom assembly 250. In one example, the upper fairing 252 is comprised of three separate segments coupled to the boom assembly 250. At least one of the segments may serve as an access panel 256 to the internal cavity.

In other embodiments, the upper fairing 252 may include one or more segments located forward of the lift surface 202 and one or more segments located aft of the lift surface 202. Utilizing multiple segments to form the upper fairing 252 may allow for access to a portion of the internal cavity of the boom assembly 250 without having to remove the entire upper fairing 252. For example, internally housed components of the lift rotor 204 may be accessible by removing a single segment of the upper fairing 252 rather than removing the entire upper fairing 252. Further, multiple segments may allow for more efficient maintenance to be performed as a damaged segment may be removed and replaced without the need to remove and replace the undamaged segments of the upper fairing 252.

In some embodiments, the upper fairing 252 may be structural, however in other examples the upper fairing 252 may be non-structural. In some embodiments, at least one segment of the upper fairing 252 may be structural, while other segments may be non-structural. For example, a forward segment and an aft segment of the upper fairing 252 may be structural while a middle segment may be non-structural. In such embodiments, the middle segment may serve as an access panel 256. In another example, the forward and aft segments of the upper fairing 252 may be non-structural and the middle segment may be structural. In such embodiments, the forward and aft segments may serve as access panels 256, such as for accessing components of the lift rotors 204.

In some embodiments, the upper fairing 252 may be made from any suitable material, such as a composite laminate or metal. In some embodiments, the upper fairing 252 may be made from a thermoset composite laminate. A cross-sectional thickness of the upper fairing 252 may be constant or may vary in thickness along the length of the boom assembly 250, such that a thickness at a first location is not equal to a thickness at a second location of the upper fairing 252. For example, the thickness may increase at locations where the upper fairing 252 mates to other parts of the boom assembly 250. Similarly, the upper fairing 252 may have a constant thickness across a respective cross-section or the thickness may vary along the respective cross-section. For example, a first portion of the respective cross-section may be thicker than a second portion of the respective cross-section to allow for coupling and/or to serve as a structural member.

In some embodiments, a cross-sectional width of the upper fairing 252 may vary along the length of the boom assembly 250. For example, the upper fairing 252 may have an aerodynamically designed profile, exhibiting a narrow width at a forward section to reduce drag and gradually increasing in width along the length to allow housing of components within the internal cavity. In some embodiments, an aft section of the upper fairing 252 may exhibit a similar narrowing taper to the forward section to reduce drag. For instance, the upper fairing 252 and lower fairing 254 together may define a missile, torpedo, and/or canoe like profile. In other embodiments, however, the width of the upper fairing 252 may not vary (e.g., remains constant) along the length of the boom assembly 250.

As shown in FIG. 4, in some embodiments the lower fairing 254 may span the length of the boom assembly 250 and may couple to the upper fairing 252. The lower fairing 254 may further couple to the ribs 270 and the canoe support structure 260. In some embodiments, the lower fairing 254 may be structural, while in other examples the lower fairing 254 may be non-structural. In embodiments where the lower fairing 254 is structural, a stressed-skin design may be employed on the boom assembly. In the stressed-skin design, the lower fairing 254 may form a structural frame with the canoe support structure 260, with both the canoe support structure 260 and the lower fairing 254 carrying a portion of the loading experienced by the boom assembly 250. Coupling the lower fairing 254 to the canoe support structure 260 may allow loading to transfer between the parts.

In some embodiments, the lower fairing 254 may be continuous along the entire length of the boom assembly 250. In such embodiments, the lower fairing 254 may be comprised of a single piece construction having a continuous unbroken profile. Having the lower fairing 254 be a structural member utilizing a single piece construction may allow loading to transfer more effectively throughout the boom assembly 250, which may reduce the overall weight of the boom assembly 250 by reducing the amount of overlapping parts and/or fasteners needed. Further, in some embodiments, where the lower fairing 254 is a single continuous piece, localized stresses due to load transfer through fasteners may be minimized, which may reduce the amount of material for the lower fairing 254 and/or a thickness of the lower fairing 254. Thus, a stronger and/or lighter boom assembly 250 may be accomplished by using a single continuous lower fairing 254.

In some embodiments, the lower fairing 254 may be made from any suitable material, such as a composite laminate or metal. In some embodiments, the lower fairing 254 is made from a thermoset composite laminate. A cross-sectional thickness of the lower fairing 254 may be constant or may vary in thickness along the length of the boom assembly 250, such that a thickness at a first location is not equal to a thickness at a second location of the lower fairing 254. For example, the thickness may increase at locations where the boom assembly 250 experiences higher loading, such as at locations where the lift rotors 204 are attached. Similarly, the lower fairing 254 may have a constant thickness across a respective cross-section or the thickness may vary along the respective cross-section. For example, a first portion of the respective cross-section may be thicker than a second portion of the respective cross-section.

In some embodiments, the thickness may vary based on the structural needs of the boom assembly 250. For instance, the thickness may decrease on a portion of the respective cross-section to minimize drawing load to that area. Similarly, the thickness may be increased in some areas of the lower fairing 254 to carry more loading. In some embodiments, a cross-sectional width of the upper fairing 252 may vary along the length of the boom assembly 250. The lower fairing 254 may be aerodynamically designed in a similar manner as the upper fairing 252. In some embodiments, the lower fairing 254 may have a canoe-like profile, tapering at the forward and aft portions and widest at a middle portion.

In some embodiments, a plurality of ribs 270 may be disposed along the length of the boom assembly 250. The ribs 270 may provide structural rigidity to the boom assembly 250, for example to minimize buckling or crippling of the upper fairing 252, the lower fairing 254, and/or the canoe support structure 260. The location of each respective rib 270 may be determined based on the design needs of the boom assembly 250. For example, more ribs 270 may be coupled between the canoe support structure 260 and the lower fairing 254 than between the canoe support structure 260 and the upper fairing 252. The ribs 270 may couple to both structural and non-structural components of the boom assembly 250. For example, at least one rib 270 may provide a coupling point for non-structural access panels 256. Thus, in embodiments, the ribs 270 may serve both a structural purpose in resisting buckling and/or crippling loads, as well as facilitate mating between parts. In some embodiments, a rib may be referred to as a bulk head.

In some embodiments the ribs 270 may comprise any suitable geometry. For example, the ribs 270 may mirror a geometry of the cavity of the boom assembly 250. In mirroring the geometry, or a portion of the geometry, of the cavity the ribs 270 may be in contact with an internal surface of the upper fairing 252 and/or the lower fairing 254.

In some embodiments, the ribs 270 may couple to various components of the boom assembly 250. In some embodiments, the ribs 270 couple to the upper fairing 252, the lower fairing 254 and the canoe support structure 260. However, in other embodiments, the ribs 270 may couple to the lower fairing 254 and the canoe support structure 260 in one location and in another location the ribs 270 couple to the upper fairing 252 and the canoe support structure 260. Further, in some embodiments the ribs 270 may be solid, having material throughout, while in other embodiments the ribs 270 may have lightening holes and/or cutouts to allow for components to be disposed within the boom assembly 250. Thus, in embodiments, the ribs 270 may resemble a frame or a former of a fuselage.

As shown in FIG. 4, in some embodiments the canoe support structure 260 may be disposed internally on the boom assembly 250, being housed within the cavity formed by the upper fairing 252 and the lower fairing 254. The canoe support structure 260 may be a structural part. In some embodiments, the canoe support structure 260 is the predominant structural part of the boom assembly 250, carrying the majority of loading experienced by the boom assembly 250. However, in other embodiments, the canoe support structure 260 couples with the lower fairing 254 and together form the structural frame that carries the majority of the loading on the boom assembly 250. The canoe support structure 260 may be made of any suitable material, such as a metal and/or a composite laminate.

In some embodiments, the canoe support structure 260 may be a continuous structural beam that spans the entirety of the length of the boom assembly 250. In some embodiments, where the canoe support structure 260 is continuous, the canoe support structure 260 may comprise a single piece construction. For example, the canoe support structure 260 may be a single piece construction comprising a plurality of co-cured sub-parts, such as co-cured composite laminates. Utilizing a single piece construction for the canoe support structure 260 may allow for a lighter canoe support structure 260 to be used since single continuous structures may better transfer stresses than compared to a structure comprising multiple mating parts. Further, the single continuous configuration of the canoe support structure 260 may reduce the number of fasteners required, thus reducing the number of fastener holes that may be drilled into the canoe support structure 260. Reducing the number of mating parts, and similarly the number of fasteners required, may reduce peak stresses from forming at various locations. Further, damage to structure often occurs as fasteners are installed and/or removed. Thus, by using a single continuous configuration for the canoe support structure 260, damage and stresses may be reduced.

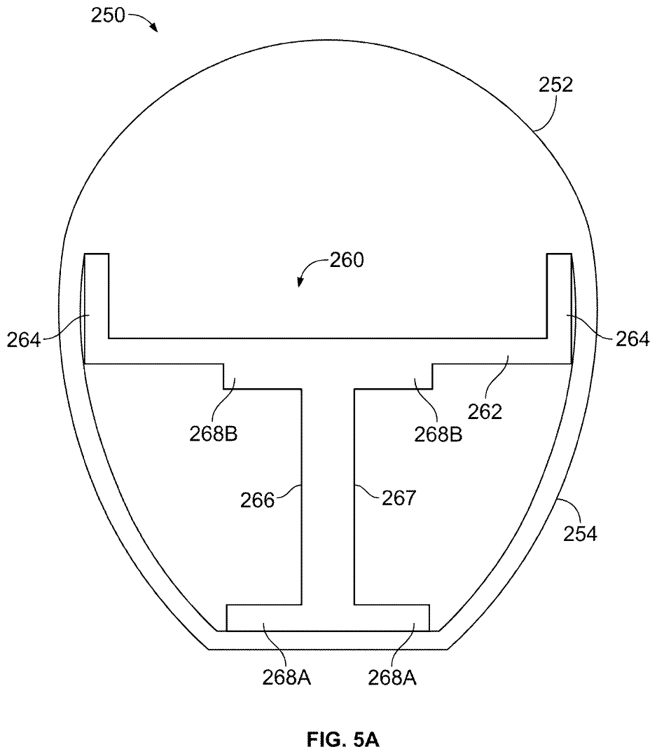

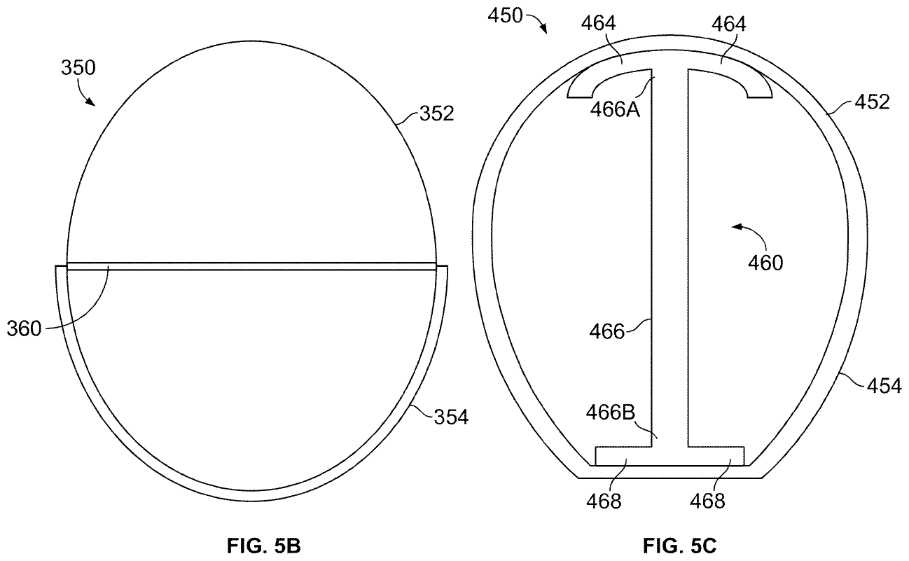

FIG. 5A is a cross-sectional view of a boom assembly 250, according to an exemplary embodiment of the present disclosure. In some embodiments, boom assembly 250 may include the upper fairing 252, the lower fairing 254, and the canoe support structure 260. The canoe support structure 260 may be internally disposed within the cavity of the boom assembly 250 formed by the upper fairing 252 and the lower fairing 254.

As shown in FIG. 5A, in some embodiments the canoe support structure 260 may include a first beam 262, a second beam 266, and a third beam 267. The first beam 262 may include flanges, such as flanges 264, which may be disposed substantially perpendicular to a first surface of the first beam 262. The second beam 266 and the third beam 267 may each respectively include a first flange 268A and a second flange 268B. With respect to the second beam 266, the first flange 268A may be disposed at a first end of the second beam 266 and oriented substantially perpendicular to a first surface of the second beam 266. The second flange 268B may be disposed at a second end, opposite the first end, of the second beam 266 and oriented substantially perpendicular to the first surface of the second beam 266. Similarly, with respect to the third beam 267, the first flange 268A may be disposed at a first end of the third beam 267 and oriented substantially perpendicular to a first surface of the third beam 267. The second flange 268B may be disposed at a second end, opposite the first end, of the third beam 267 and oriented substantially perpendicular to the first surface of the third beam 267. The dimensions of the second beam 266 may be equal to the dimensions of the third beam 267. Thus, in some examples, the second beam 266 and the third beam 267 may be symmetrical to one another and mirror one another. The terms substantially parallel, substantially horizontal, and substantially perpendicular, as used herein, mean a variance within 20 degrees of parallel, horizontal, and perpendicular, respectively.

While FIG. 5A shows the canoe support structure 260 including a plurality of flanges, in some embodiments the canoe support structure 260 may not include any flanges. In other embodiments, the first beam 262 may not include any flanges, and the second beam 266 and the third beam 267 include at least one flange. In some embodiments, flange 264 may be located on both the first side and a second side, opposite the first side, of the first beam 262. While in other embodiments, flange 264 is located on the second side of the first beam 262.

In some embodiments, the first flange 268A and the flange 264 may couple to a surface of the lower fairing 254, which may aid in transferring loading between the lower fairing 254 and the canoe support structure 260. The first flange 268A and the flange 264 may increase the coupling surface area between the respective parts. In some embodiments, where the canoe support structure 260 is coupled to the lower fairing 254 via adhesive, the first flange 268A and the flange 264 may increase a bond surface area, which may reduce shear stresses and mitigate bond failure modes from occurring. The increased coupling surface may help to minimize point load stresses by distributing the load transferred between the lower fairing 254 and the canoe support structure 260.

In some embodiments, the first beam 262, the second beam 266, and the third beam 267 may be coupled together to form a single continuous structure for the canoe support structure 260. For example, a second surface, opposite the first surface, of the second beam 266 may be coupled to a second surface, opposite the first surface, of the third beam 267 with the resulting configuration forming an I-beam design. The first beam 262 may then couple to both the second beam 266 and the third beam 267 and may be oriented orthogonal to the respective first surfaces of the second beam 266 and the third beam 267. As shown in FIG. 5A, in some embodiments the second flanges 268B may facilitate coupling between the first beam 262 and the second beam 266 and the third beam 267. The second flanges 268B may increase coupling surface area between the respective parts and/or more effectively distribute loading throughout the canoe support structure 260.

In some embodiments, the first beam 262 may have a thickness equal to a thickness of the second beam 266 and/or the third beam 267. However, in other examples, the thickness of the first beam 262 is not equal to the thickness of the second beam 266 and/or the third beam 267. In some embodiments, the first beam 262 may be thicker than the second beam 266 and/or the third beam 267. The thickness of the first beam 262 may be constant along a respective cross-section in some examples, while in other embodiments the thickness may not be constant. For instance, the first beam 262 may be tapered at a respective cross-section to be narrowest at each end and thickest at a midpoint. At some locations first beam 262 may have a portion of material removed (e.g., cutouts) that may allow for coupling of various components, such as components of the lift rotors and/or electrical wiring. The cross-sectional thickness may increase in the first beam 262 at locations where the various components are coupled. In some examples, the canoe support structure 260 may include doublers at locations where the various components are coupled.

In some embodiments, the canoe support structure 260 may be configured to match the geometry of an internal surface of the boom assembly 250. In some embodiments, the flange 264 and the first flange 268A may be straight or curved to match the design of the lower fairing 254 and/or the upper fairing 252.

In some embodiments, the canoe support structure 260 may be a carbon fiber and epoxy laminate is used. In some embodiments, more than one material may be used. For example, the first beam 262 may be made from a composite laminate, while the second beam 266 and the third beam 267 are made from a metal, such as aluminum or titanium. In other embodiments, at least one beam includes both a metal and a composite laminate. Other combinations and/or materials are possible.

FIG. 5B is a cross-sectional view of a boom assembly 350, according to an exemplary embodiment of the present disclosure. In some examples, the boom assembly 350 may have similar aspects, features, and/or capabilities as described with respect to the boom assembly 250. In some embodiments, the boom assembly 350 may include an upper fairing 352, a lower fairing 354, and a canoe support structure 360. The canoe support structure 360 may be a single continuous structural beam that spans a width of the internal cavity and couples to the lower fairing 354 to form a closed structural unit. In some embodiments, the canoe support structure 360 may be a substantially planar beam that spans a width of the cross-section of the boom assembly 350. In some examples, the canoe support structure 360 includes at least one flange that couples to the lower fairing 354.

FIG. 5C is a cross-sectional view of a boom assembly 450, according to an exemplary embodiment of the present disclosure. In some examples, the boom assembly 450 may have similar aspects, features, and/or capabilities as described with respect to the boom assembly 250 and/or 350. In some embodiments, the boom assembly 450 may include an upper fairing 452, a lower fairing 454, and a canoe support structure 460. The canoe support structure 460 may be internally disposed within a cavity of the boom assembly 450 formed by the upper fairing 452 and the lower fairing 454.

As shown in FIG. 5C, in some embodiments the canoe support structure 460 may include a beam 466, a first flange 464, and a second flange 468. The beam 466 may include a first end 466A and a second end 466B disposed opposite the first end 466A. The first flange 464 may be coupled to the beam 466 at the first end 466A and the second flange 468 may be coupled at the second end 466B. In some examples, the first and/or second flange 464 and/or 468 may be disposed at an angle to the beam 466, such as disposed at a substantially perpendicular angle to the beam 466. At least one surface of the first flange 464 and/or the second flange 468 may mirror and/or conform to a mating surface. For example, at least one surface of the first flange 464 and/or the second flange 468 may conform to an internal surface of either the upper and/or lower fairing 452 and 454, which may provide more contact between respective surfaces for improved coupling and load transfer. As shown, the beam 466, the first flange 464, and the second flange 468 may form an I-beam configuration for the canoe support structure 460 where the I-beam extends from the upper fairing 452 to the lower fairing 454. While the canoe support structure 460 forms an I-Beam configuration having at least one plane of symmetry in some examples, in other examples the canoe support structure 460 may be asymmetrical.

In some embodiments, the first flange 464 and/or the second flange 468 may couple to a surface of the internal cavity formed by the upper and lower fairings 452 and 454, which may aid in transferring loading between the canoe support structure 460 and the upper and/or lower fairing 452 and 454. The first flange 464 and the second flange 468 may increase the coupling surface area between the respective parts. In some embodiments, where the canoe support structure 460 is coupled to the lower fairing 454 via adhesive, the second flange 468 may increase a bond surface area, which may reduce shear stresses and mitigate bond failure modes from occurring. The increased coupling surface may help to minimize point load stresses by distributing the load transferred between the lower fairing 454 and the canoe support structure 460.

In some embodiments, the thickness of the beam 466 may be constant along a respective cross-section, while in other embodiments the thickness may not be constant. For instance, the beam 466 may be tapered at a respective cross-section to be narrowest at the first and/or second ends 466A and 466B and thickest at a point between the first and second ends 466A and 466B, such as a midpoint. At some locations along a length of the beam 466 a portion of material may be removed (e.g., cutouts) to allow for coupling of various components, such as components of the lift rotors, batteries, and/or electrical wiring. The cross-sectional thickness may increase in the beam 466 at locations where the various components are coupled. In some examples, the canoe support structure 460 may include doublers at locations where the various components are coupled.

In some embodiments, the first flange 464 and/or the second flange 468 may be integrally formed with the beam 466. For example, where the canoe support structure 460 is made from a composite laminate at least one of the first flange 464 and/or the second flange 468 may share a same fiber (e.g., fiber tow and/or fiber sheet) with the beam 466 such that the first flange 464 and/or the second flange 468 is integral with the beam 466. However, in other embodiments the first flange 464 and/or the second flange 468 may be co-cured with the beam 466 to form an integral canoe support structure 460. For example, the first flange 464 and/or the second flange 468 may be manufactured separate from the beam 466 then assembled with the beam 466 in an uncured state to form an uncured canoe support structure. The uncured canoe support structure may be cured such that the beam 466 and the first and second flanges 464 and 468 are co-cured together in the canoe support structure 460 being integrally formed. In further embodiments, the upper and/or lower fairing 452 and/or 454 may be assembled and co-cured along with the canoe support structure 460 such that one or more components on the boom assembly 450 are integrally formed through co-curing.

In some embodiments, the canoe support structure 460 may be a carbon fiber and epoxy laminate is used. In some embodiments, more than one material may be used. For example, the beam 466 may be made from a composite laminate, while the first and/or second flanges 464 and 468 are made from a metal, such as aluminum or titanium. In other embodiments, at least component of the canoe support structure 460 includes both a metal and a composite laminate. Other combinations and/or materials are possible.

Thus, in various embodiments one or more components in the boom assembly 250, 350, and/or 450 may be made from any suitable material, such as made from a composite and/or a metal. For example, where the boom assembly includes a composite, the one or more components may be made from a thermoset composite in some embodiments, while in other embodiments a thermoplastic composite may be used. In further embodiments, one or more components may include both a composite and a metal. The determined material for use may be based on one or more design needs, such as based on favorable weight characteristics and/or material properties.

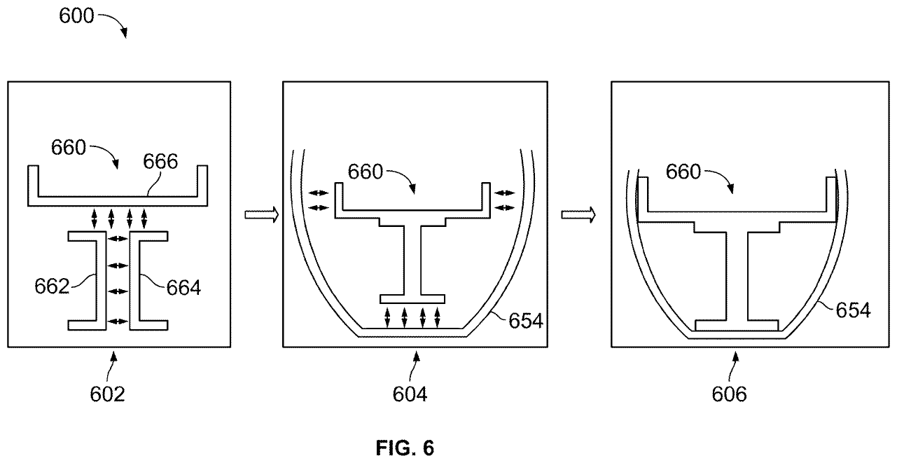

FIG. 6 is a process flow 600 for assembling structural components of a boom assembly, according to an exemplary embodiment of the present disclosure. In some embodiments, a canoe support structure 660 may be assembled from various components to form a single continuous support structure. The canoe support structure 660 may then be coupled to an internal surface of a lower fairing 654.

The process flow 600 may include one or more operations, or actions as illustrated by one or blocks 602-606. Although the blocks are illustrated in a sequential order, these block may in some instances be performed in parallel, and/or in a different order than those described herein. Also, the various blocks may be combined into fewer steps, divided into additional steps, and/or removed based upon the desired implementation.

In block 602 of the process flow 600 the canoe support structure 660 may be formed from a first beam 662, a second beam 664, and a third beam 666. A first surface of the first beam 662 may couple to a first surface of the second beam 664. In some embodiments, an I-beam configuration is formed by the coupled first and second beams. The third beam 666 may couple to a second surface of both the first and second beams. Coupling may be performed by any suitable means. For example, the respective beams may each be cured separately then bonded together post-cure, using adhesive, to form the canoe support structure 660.

However, it may be structurally advantageous in some embodiments to produce a single continuous structure that does not comprise adhesively bonding individual components post-cure. Thus, in some embodiments the canoe support structure 660 may comprise at least one co-cured component. For example, the first beam 662, the second beam 664, and/or the third beam 666 may be assembled to a desired configuration, such as the configuration shown in block 602, and together co-cured to form a single continuous structure for the canoe support structure 660. In some examples, an adhesive is added between one or more mating surfaces, such as between mating surfaces of the first beam 662, the second beam 664, and/or the third beam 666. Adding an adhesive between the one or more mating surfaces prior to co-curing may improve bond strength between the co-cured components. The canoe support structure 660 may be co-cured using a vacuum bag, an autoclave, and or any suitable technique now known or later discovered by those having skill in the art. Co-curing may advantageously produce a stronger canoe support structure 660, as compared to post-cure bonding, by allowing the canoe support structure 660 to function as a single continuous unbroken part when transferring loading. Functioning as a single continuous unbroken part may yield structural advantageous by reducing bond failure concerns experienced with post-cure adhesives, and/or reducing the need for drilling fastener holes which may weaken the mechanical properties of the canoe support structure 660.

In block 604 of the process flow 600 the canoe support structure 660 formed in block 602 may be coupled to a lower fairing 654. Coupling may be performed using any suitable means, such as bonding using adhesives post-cure. In some embodiments, coupling may be performed by co-curing the canoe support structure 660 to the lower fairing 654. With co-curing, at least one surface of the canoe support structure 660 may be placed in contact with a surface of the lower fairing 654. Together the canoe support structure 660 and the lower fairing 654 may then be cured such that after curing the canoe support structure 660 is fixedly coupled with the lower fairing 654. This may allow the canoe support structure 660 and the lower fairing 654 to function as a single continuous part when transferring loading throughout the boom assembly. By functioning as a single continuous part, loading may more effectively transfer between the canoe support structure 660 and the lower fairing 654. This may reduce the need for additional fasteners and/or adhesives to couple the canoe support structure 660 to the lower fairing, which may allow for a lighter and/or stronger boom assembly. In some embodiments, the lower fairing 654 may use a similar matrix and/or fiber as the canoe support structure 660.

Using a similar matrix and/or fiber may allow co-curing to be performed more effectively due to the canoe support structure 660 having similar material properties as the lower fairing 654.

In some embodiments, the lower fairing 654 may be a structural skin. However, in other embodiments, the lower fairing 654 may be non-structural and may predominantly serve as an aerodynamic fitting. In some examples, more than one method of coupling may be used. For instance, the canoe support structure 660 may be coupled to the lower fairing 654 by co-curing and fasteners.

Block 606 of the process flow 600 shows an example of the canoe support structure 660 and the lower fairing 654 coupled together. Once coupled, the canoe support structure 660 and the lower fairing 654 may then be coupled with other components of the boom assembly, such as the ribs and/or the upper fairing.

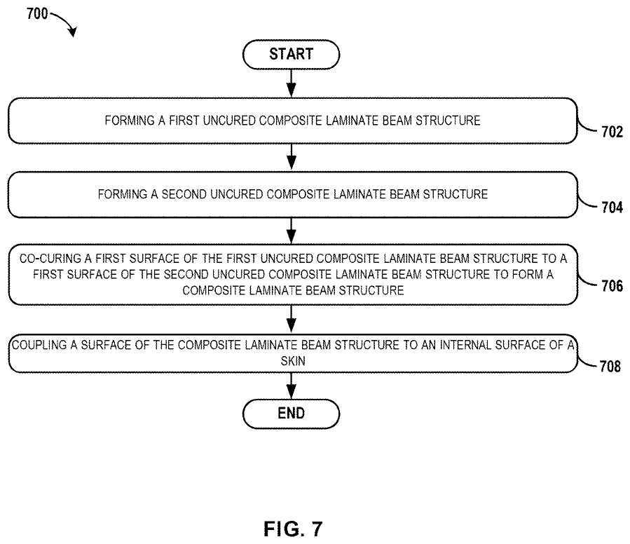

FIG. 7 is a flow chart of an example method 700 of forming a structural portion of a boom assembly, according to an exemplary embodiment of the present disclosure. In some examples, at least a portion of the boom assembly 150 and/or the boom assembly 250 may be formed by the method 700.

The method 700 may include one or more operations, or actions as illustrated by one or more steps 702-708. Although the steps are illustrated in a sequential order, these steps may in some instances be performed in parallel, and/or in a different order than those described herein. Also, the various blocks may be combined into fewer steps, divided into additional steps, and/or removed based upon the desired implementation.

In addition, for the method 700 and other processes and operations disclosed herein, the flowchart shows operation of one possible implementation of present examples. In this regard, each step may represent a module, a segment, or a portion of program code, which includes one or more instructions executable by a processor or a controller for implementing specific logical operations or steps in the process. The program code may be stored on any type of computer readable medium or memory, for example, such as a storage device including a disk or hard drive. The computer readable medium may include a non-transitory computer readable medium or memory, for example, such as computer-readable media that stores data for short periods of time like register memory, processor cache and Random Access Memory (RAM). The computer readable medium may also include non-transitory media or memory, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage device, or other article of manufacture, for example. In addition, for the method 700 and other processes and operations disclosed herein, one or more steps in FIG. 7 may represent circuitry or digital logic that is arranged to perform the specific logical operations in the process.

As illustrated, the method may include step 702 of forming, by arranging at least one composite material to a first determined configuration, a first uncured composite laminate beam structure.

The method 700 may also include step 704 of forming, by arranging at least one composite material to a second determined configuration, a second uncured composite laminate beam structure.

The method 700 may also include step 706 of co-curing a first surface of the first uncured composite laminate beam structure to a first surface of the second uncured composite laminate beam structure to form a composite laminate beam structure. The composite laminate beam structure is a single continuous structure.

The method 700 may also include step 708 of coupling a surface of the composite laminate beam structure to an internal surface of a skin.

In some examples, the method 700 may further include, prior to co-curing, applying an adhesive between the first surface of the first uncured composite laminate beam structure and the first surface of the second uncured composite laminate beam structure.

In some examples of the method 700, forming the first uncured composite laminate beam structure further includes arranging a plurality of carbon fiber plies on a mold; sealing the arranged plurality of carbon fiber plies in a vacuum bag; and injecting a matrix into the vacuum bag.

In some examples of the method 700, co-curing a first surface of the first uncured composite laminate beam structure to a first surface of the second uncured composite laminate beam structure further includes co-curing a bulkhead to the composite laminate beam structure.

In some examples, the method 700 further includes forming, by arranging at least one composite material to a third determined configuration, a first uncured composite laminate flange; and co-curing a first surface of the first uncured composite laminate flange to a second surface of the first uncured composite laminate beam structure.

In some examples of the method 700, coupling the surface of the composite laminate beam structure to the internal surface of the skin includes bonding a first surface of the composite laminate beam structure to a first internal surface of the skin and detachably coupling a second surface of the composite laminate beam structure to a second internal surface of the skin.

In some examples, the method 700 further includes forming, by arranging at least one composite material to a third determined configuration, a third uncured composite laminate beam structure; and co-curing a second surface of the first uncured composite laminate beam structure to a first surface of the third uncured composite laminate beam structure such that the composite laminate beam structure forms a continuous I-beam configuration.

In some such examples, the method 700 further includes co-curing respective second surfaces of the second and third uncured composite laminate beam structure to the internal surface of the skin.

In some examples of the method 700, coupling the composite laminate beam structure to the skin includes co-curing the composite laminate beam structure to the skin.

In some examples, the method 700 further includes, prior to co-curing the composite laminate beam structure to the skin, applying an adhesive between coupling surfaces of the composite laminate beam structure and the skin.

Implementations of the present disclosure can thus relate to one of the example embodiments listed below.

Embodiment 1 is a method of forming a structural component, the method comprising: forming, by arranging at least one composite material to a first determined configuration, a first uncured composite laminate beam structure; forming, by arranging at least one composite material to a second determined configuration, a second uncured composite laminate beam structure; co-curing a first surface of the first uncured composite laminate beam structure to a first surface of the second uncured composite laminate beam structure to form a composite laminate beam structure, wherein the composite laminate beam structure is a single continuous structure; and coupling a surface of the composite laminate beam structure to an internal surface of a skin.

Embodiment 2 is the method according to embodiment 1, the method further comprising prior to co-curing, applying an adhesive between the first surface of the first uncured composite laminate beam structure and the first surface of the second uncured composite laminate beam structure.

Embodiment 3 is the method according to embodiment 1 or embodiment 2, wherein forming the first uncured composite laminate beam structure further comprises: arranging a plurality of carbon fiber plies on a mold; sealing the arranged plurality of carbon fiber plies in a vacuum bag; and injecting a matrix into the vacuum bag.

Embodiment 4 is the method according to any of embodiments 1 to 3, wherein co-curing a first surface of the first uncured composite laminate beam structure to a first surface of the second uncured composite laminate beam structure further comprises co-curing a bulkhead to the composite laminate beam structure.

Embodiment 5 is the method according to any of embodiments 1 to 4, further comprising forming, by arranging at least one composite material to a third determined configuration, a first uncured composite laminate flange; and co-curing a first surface of the first uncured composite laminate flange to a second surface of the first uncured composite laminate beam structure.

Embodiment 6 is the method according to any of embodiments 1 to 5, wherein coupling the surface of the composite laminate beam structure to the internal surface of the skin comprises bonding a first surface of the composite laminate beam structure to a first internal surface of the skin and detachably coupling a second surface of the composite laminate beam structure to a second internal surface of the skin.

Embodiment 7 is the method according to any of embodiments 1 to 6, further comprising forming, by arranging at least one composite material to a third determined configuration, a third uncured composite laminate beam structure; and co-curing a second surface of the first uncured composite laminate beam structure to a first surface of the third uncured composite laminate beam structure such that the composite laminate beam structure forms a continuous I-beam configuration.

Embodiment 8 is the method according to any of embodiments 1 to 7, further comprising co-curing respective second surfaces of the second and third uncured composite laminate beam structure to the internal surface of the skin.

Embodiment 9 is the method according to any of embodiments 1 to 8, wherein coupling the composite laminate beam structure to the skin comprises co-curing the composite laminate beam structure to the skin.

Embodiment 10 is the method according to any of embodiments 1 to 9, further comprising, prior to co-curing the composite laminate beam structure to the skin, applying an adhesive between coupling surfaces of the composite laminate beam structure and the skin.

Embodiment 11 is an aerial vehicle comprising a body, a lift surface coupled to the body; and a boom coupled to the lift surface at a distance from the body, the boom comprising: a first fairing, a second fairing coupled to the first fairing, wherein the second fairing is a continuous structural member, and a continuous structural beam internally disposed within a cavity formed by the first and second fairings, and coupled to a surface of the second fairing, wherein the continuous structural beam is formed of a first composite laminate co-cured with a second composite laminate.

Embodiment 12 is the aerial vehicle according to embodiment 11, wherein the continuous structural beam is co-cured with the second fairing.

Embodiment 13 is the aerial vehicle according to embodiment 11 or embodiment 12, wherein the continuous structural beam forms an I-beam.

Embodiment 14 is the aerial vehicle according to any of embodiments 11 to 13, wherein a first surface of the I-beam is coupled to the surface of the second fairing and a second surface of the I-beam is coupled to a surface of the first fairing.

Embodiment 15 is the aerial vehicle according to any of embodiments 11 to 14, wherein the I-beam bisects the boom into a first and second sides, and wherein the first fairing comprises a first access panel that allows access to the first side and a second access panel that allows access to the second side.

Embodiment 16 is the aerial vehicle according to any of embodiments 11 to 15, wherein the second fairing comprises a structural skin.

Embodiment 17 is the aerial vehicle according to any of embodiments 11 to 16, wherein the first composite laminate is co-cured to the second composite laminate at a substantially perpendicular angle.

Embodiment 18 is the aerial vehicle according to any of embodiments 11 to 17, wherein the first composite laminate extends a width of the second fairing such that the first composite laminate is coupled to opposite surfaces of the second fairing.

Embodiment 19 is the aerial vehicle according to any of embodiments 11 to 18, wherein the second composite laminate is coupled to the surface of the second fairing at a substantially perpendicular angle to the first composite laminate.

Embodiment 20 is the aerial vehicle according to any of embodiments 11 to 19, wherein the first composite laminate forms a structural skin and the second composite laminate forms a floor.

The above detailed description describes various features and functions of the disclosed systems, apparatus, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

What is claimed is:

1. A method of forming a structural component, the method comprising:
forming, by arranging at least one composite material to a first determined configuration, a first uncured composite laminate beam structure;
forming, by arranging at least one composite material to a second determined configuration, a second uncured composite laminate beam structure;
co-curing a first surface of the first uncured composite laminate beam structure to a first surface of the second uncured composite laminate beam structure to form a composite laminate beam structure, wherein the composite laminate beam structure is a single continuous structure; and
coupling a surface of the composite laminate beam structure to an internal surface of a skin.

2. The method of claim 1, further comprising prior to co-curing, applying an adhesive between the first surface of the first uncured composite laminate beam structure and the first surface of the second uncured composite laminate beam structure.

3. The method of claim 1, wherein forming the first uncured composite laminate beam structure further comprises:
arranging a plurality of carbon fiber plies on a mold;
sealing the arranged plurality of carbon fiber plies in a vacuum bag;
injecting a matrix into the vacuum bag.

4. The method of claim 1, wherein co-curing a first surface of the first uncured composite laminate beam structure to a first surface of the second uncured composite laminate beam structure further comprises co-curing a bulkhead to the composite laminate beam structure.

5. The method of claim 1, further comprising forming, by arranging at least one composite material to a third determined configuration, a first uncured composite laminate flange; and co-curing a first surface of the first uncured composite laminate flange to a second surface of the first uncured composite laminate beam structure.

6. The method of claim 1, wherein coupling the surface of the composite laminate beam structure to the internal surface of the skin comprises bonding a first surface of the composite laminate beam structure to a first internal surface of the skin and detachably coupling a second surface of the composite laminate beam structure to a second internal surface of the skin.

7. The method of claim 1, further comprising:
forming, by arranging at least one composite material to a third determined configuration, a third uncured composite laminate beam structure; and
co-curing a second surface of the first uncured composite laminate beam structure to a first surface of the third uncured composite laminate beam structure such that the composite laminate beam structure forms a continuous I-beam configuration.

8. The method of claim 7 further comprising co-curing respective second surfaces of the second and third uncured composite laminate beam structure to the internal surface of the skin.

9. The method of claim 1, wherein coupling the composite laminate beam structure to the skin comprises co-curing the composite laminate beam structure to the skin.

10. The method of claim 9, further comprising, prior to co-curing the composite laminate beam structure to the skin, applying an adhesive between coupling surfaces of the composite laminate beam structure and the skin.

11. An aerial vehicle comprising:
a body;
a lift surface coupled to the body; and
a boom coupled to the lift surface at a distance from the body, the boom comprising:
a first fairing,
a second fairing coupled to the first fairing, wherein the second fairing is a continuous structural member, and
a continuous structural beam internally disposed within a cavity formed by the first and second fairings, and coupled to a surface of the second fairing, wherein the continuous structural beam is formed of a first composite laminate co-cured with a second composite laminate.

12. The aerial vehicle of claim 11, wherein the continuous structural beam is co-cured with the second fairing.

13. The aerial vehicle of claim 11, wherein the continuous structural beam forms an I-beam.

14. The aerial vehicle of claim 13, wherein a first surface of the I-beam is coupled to the surface of the second fairing and a second surface of the I-beam is coupled to a surface of the first fairing.

15. The aerial vehicle of claim 13, wherein the I-beam bisects the boom into a first and second sides, and wherein the first fairing comprises a first access panel that allows access to the first side and a second access panel that allows access to the second side.

16. The aerial vehicle of claim 11, wherein the second fairing comprises a structural skin.

17. The aerial vehicle of claim 11, wherein the first composite laminate is co-cured to the second composite laminate at a substantially perpendicular angle.

18. The aerial vehicle of claim 17, wherein the first composite laminate extends a width of the second fairing such that the first composite laminate is coupled to opposite surfaces of the second fairing.

19. The aerial vehicle of claim 18, wherein the second composite laminate is coupled to the surface of the second fairing at a substantially perpendicular angle to the first composite laminate.

20. The aerial vehicle of claim 11, wherein the first composite laminate forms a structural skin and the second composite laminate forms a floor.
